(19) United States
(12) Patent Application Publication
(10) Pub. No.: US 2002/0147832 A1
(43) Pub. Date: Oct. 10, 2002

(54) Framing and processing messages

(76) Inventors: Ylian Saint-Hilaire, Hillsboro, OR (US); Frederick William Strahm, Hillsboro, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/828,628

(22) Filed: Apr. 5, 2001

(51) Int. Cl. G06F 15/16

(52) U.S. Cl. 709/236

(57) ABSTRACT

Framing and processing messages includes preparing information included in a stream of information that requires reliable transmission from a source to a destination for transmission across a network link, separately preparing other information included in the stream that does not require reliable transmission to the destination for transmission across the network link, and preparing the stream for transmission across the network link.

### BACKGROUND

This invention relates to framing and processing messages.

Mobile agents include devices such as laptop and portable computers, personal digital assistants, telephones, and other wireless or personal devices capable of connecting to a network from varied locations. To connect to an Internet Protocol (IP) based network, for example, a mobile agent needs to establish a network presence that allows information to be sent between the mobile agent and arbitrary points in the IP network.

Referring to FIG. 1, for example, a mobile agent 100 can wirelessly and continuously be connected to a network infrastructure 102 using the same IP address regardless of the mobile agent's physical location. The mobile agent 100 is identified by a home address providing information about the mobile agent's home network 104. When the mobile agent 100 connects to the network infrastructure 102 away from its home link 106, the mobile agent 100 is identified by the home address and by at least one care-of address providing information about the mobile agent's current location.

Information sent across the network infrastructure 102 to the mobile agent's home address is transparently routed to the mobile agent's care-of address. The information destined for the mobile agent's home address is received at the home link 106 by a home gateway or router 108 that tunnels the information to the mobile agent's care-of address via an IP tunnel 110. The care-of address may be an address for a foreign gateway or router 112 that forwards the information to the mobile agent 100 over a foreign link 114 that does not use IP routing.

As the mobile agent 100 changes its physical location and switches to a different foreign gateway or router to maintain connectivity to the network infrastructure 102, the mobile agent 100 updates the home gateway or router 108 with its new care-of address. In this way, the mobile agent 100 can relocate, connect to various foreign gateways or routers, and maintain a constant IP address presence without interruptions or disturbances in network connectivity. In switching between foreign gateways or routers, however, information may be lost in transit from the mobile agent 100 to the home network 104.

### DESCRIPTION OF DRAWINGS

FIG. 1 (PRIOR ART) is a block diagram of a network arrangement.

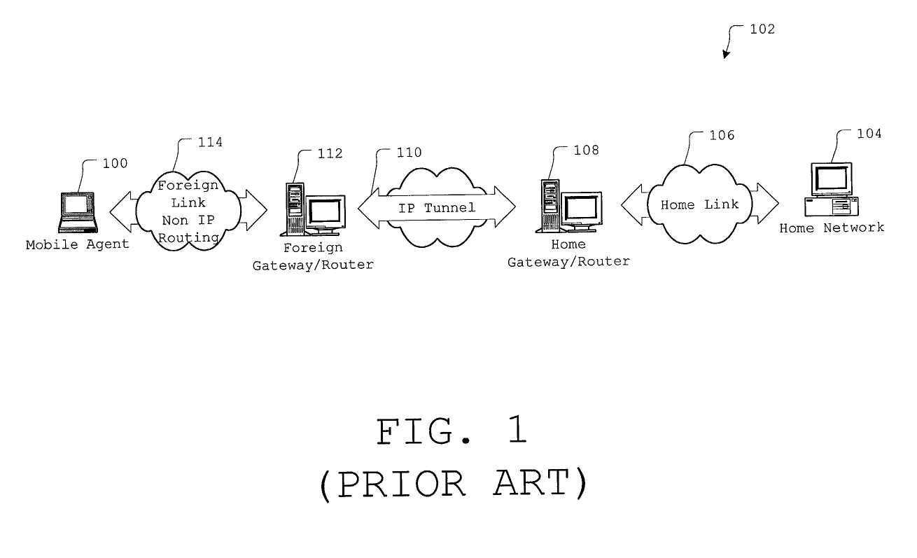

FIG. 2 is a block diagram of a simplified network configuration.

FIG. 3 is another view of the simplified network configuration of FIG. 2.

FIG. 4 is another view of the view in FIG. 3.

FIG. 5 is a block diagram of a stack.

FIG. 6 is a block diagram showing a source-side processing configuration.

FIG. 7 is a block diagram showing a destination-side processing configuration.

### DESCRIPTION

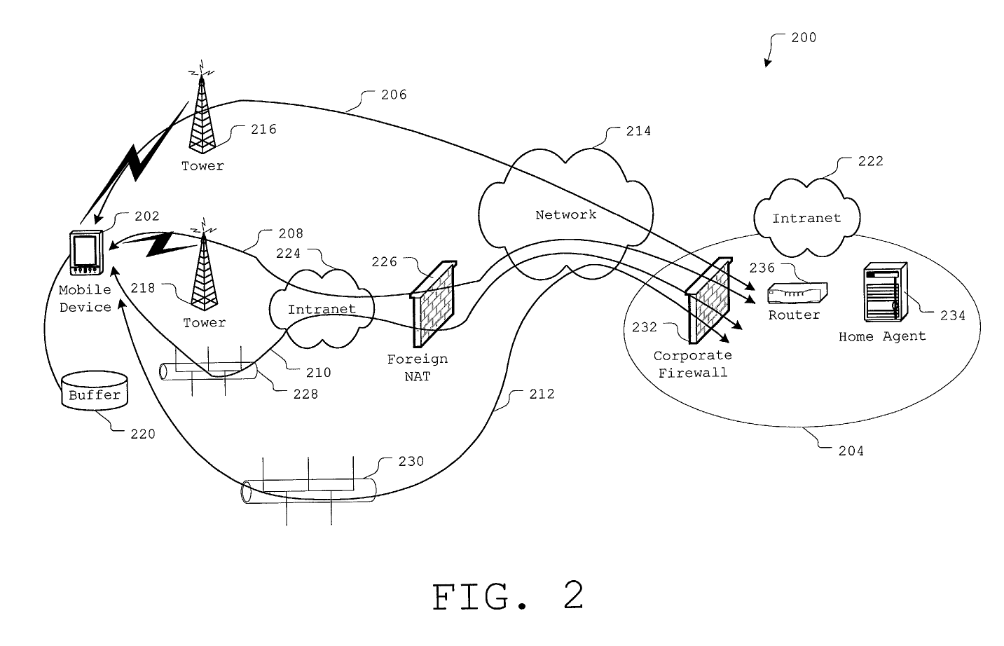

Referring to FIG. 2, in an example of a network configuration 200, a mobile unit (mobile device) 202 can establish a reliable Transmission Control Protocol (TCP) connection (TCP tunnel) with a home network 204 across a network 214 using an available network interface. The available interface currently in use is called the active interface while the remaining available interfaces (if any) are called passive interfaces. Examples of such network interfaces include a wireless interface 206, a wireless local area network (LAN) interface 208, a wired network interface 210, a direct wired interface 212, and other similar interfaces. Each of the interfaces 206, 208, 210, and 212 is described further below.

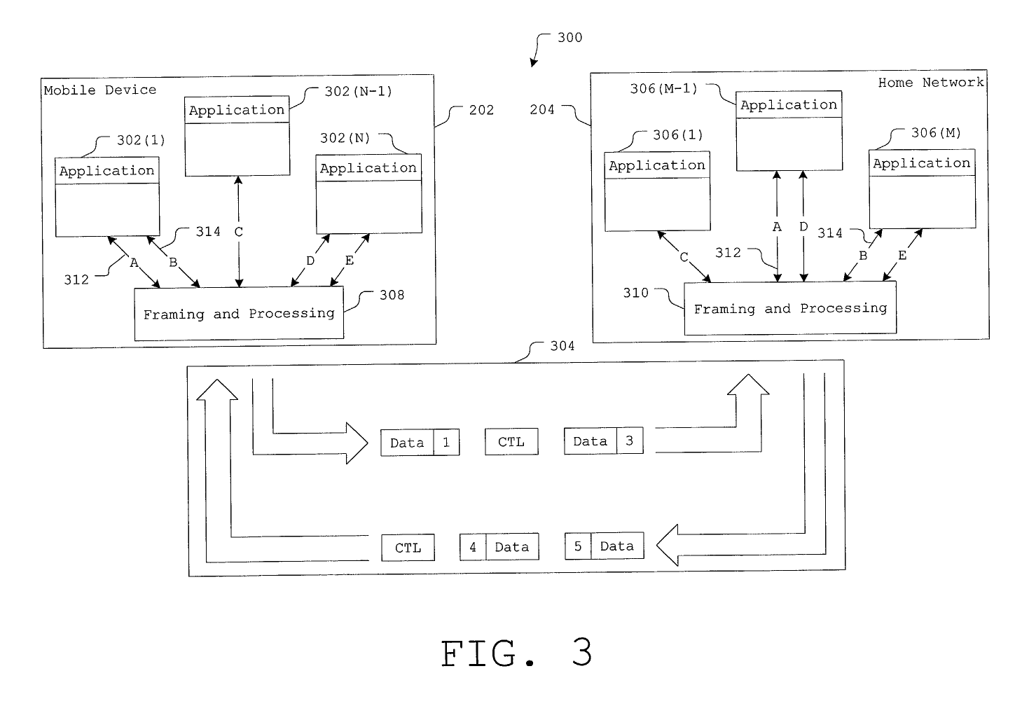

Referring to FIG. 3, in another view 300 of the network configuration 200 (see FIG. 2), information sent from multiple mobile applications 302(1)-302(N) included in the mobile device 202 may be aggregated into one stream of information for transmission across an active interface 304 (e.g., one of the interfaces 206, 208, 210, or 212) to multiple home applications 306(1)-306(M). (N and M each represent integers greater than zero.)

The mobile applications 302(1)-302(N) and the home applications 306(1)-306(M) may act as if they have individual peer-to-peer connections although they share the single active interface 304. For example, one mobile application 306(1) may appear to have a first peer-to-peer connection 312 with one home application 306(M−1) and another peer-to-peer connection 314 with another home application 306(M) when the single active interface 304 includes both the peer-to-peer connections 312 an 314.

The home applications 306(1)-306(M) may run on a home agent 234 or on another device (e.g., a local or remote server, a local or remote server farm, etc.) accessible through the home network 204. For simplicity in this example, only one application 302(1) (“mobile application” 302) included in the mobile device 202 is discussed as attempting to communicate with one application 306(1) (“home application” 306) accessible by the home agent 234.

Before sending information onto the active interface 304, the mobile device 202 processes and frames the information using a mobile processing and framing mechanism 308 (“mobile fp unit” 308). The mobile device 202 splits both the framing and the processing into multiple stages. The mobile fp unit 308 processes information requiring reliable transmission (called “reliable information”) across the active interface 304 in an application-specific way, frames the information, processes information not requiring reliable transmission (called “unreliable information”) in an application-specific way, frames the information, and processes the framed reliable and unreliable information in a stream-specific way. If the information is not sent as a stream, the mobile fp unit 308 need not perform the stream-specific processing.

By splitting the framing into multiple stages, application-specific processing such as mobility hand-off processing can be performed at the proper place for information following different transmission policies and requiring different transmission guarantees. Furthermore, the mobile fp unit 308 can skip one or more processing operations in processing unreliable information for transmission on the active interface 304, thereby potentially saving processing resources and/or speeding up the transmission of unreliable information onto the active interface 304.

For example, the information may include an aggregation of data from two different applications, one application requiring reliable transport of its information (e.g., order-sensitive video data) while the other application may not require reliable transmission of its data (e.g., web page text). The mobile fp unit 308 can process and frame the reliable data in two stages, process and frame the unreliable data in another two stages, and process a stream including the reliable data and the unreliable data in another stage. Examples of these framing and processing stages are discussed further below.

The mobile fp unit 308 can communicate with a home framing and processing mechanism 310 (“home fp unit” 310) included in the home agent 234 over the active interface 304. Analogous to operations performed by the mobile fp unit 308, the home fp unit 310 de-frames (accumulates) and processes the information in multiple accumulating and processing stages upon the information's receipt from the active interface 304. Because of the split de-framing operations, depending on the traffic type of the information, the home agent 234 may not need to wait for receipt of a full frame before forwarding the information to its ultimate destination, the home application 306.

Framing generally refers to preparing the information for transmission on the active interface 304 using a particular protocol by, for example, appending a header to each application fragment included in the information. The header includes reference information for the fragment, e.g., an index number, a fragment size, and other similar information. Framing may also include adding control information to the application fragments. De-framing generally involves removing any header information and control information from the information.

Processing generally refers to preparing the information for or handling the information after transmission on the active interface 304 according to one or more policies imposed, required, or suggested by the application sending the information, the active interface 304, the mobile device 202, and/or the home network 204. Examples of processing operations may include roundtrip and bandwidth optimization, compression, security (privacy, integrity, etc.), quality of service (QoS), proxy traversal, resistance to connection (interface) loss, reliable handoff of traffic to a new active interface, stream aggregation, and other similar operations. These processing operation examples may apply to some or all information types, e.g., reliable stream-based information, unreliable packet-based information, control data, etc.

Generally, an application is a software-based configuration program that runs, for example, on a system having processing capabilities such as a mobile or stationary telephone, computer, server, or other device. The applications 302(1)-302(N) and 306(1)-306(M) can each include a collection of functions and/or data stored in binary format (or a combination of binary format and text format) and configuration information associated with the collection of functions and/or data.

Examples of the applications 302(1)-302(N) and 306(1)-306(M) may include:

a) a file that a unit directly executes such as an executable (EXE) file, a command (COM) file, a drive (DRV) file, a phone (FON) file, and other similar files,

b) a collection of files that a unit directly executes such as a dynamic link library (DLL) and other similar collections of files,

c) a routine or application program interface (API) such as Adobe Acrobat™, Paintshop Pro™, and other similar routines and APIs,

d) a proxy acting on behalf of another device, and

e) network software.

A variety of interfaces may be available to the mobile device 202. The mobile device 202 may choose an available interface to be the active interface based on an order of preference. An example of an order of preference from most preferable to least preferable may be: a) wired Ethernet, b) short distance, low power Bluetooth, c) medium distance IEEE802.11b, d) long distance CDPD.

The mobile device 202 and/or the home agent 234 may be able to determine if additional interfaces should be opened (i.e., be made available). For example, parameters can be set for opening interfaces based on factors such as a fee levied for using a particular interface, connection speed, signal strength, latency, and available security. The mobile device 202 may be able to detect its geographic location to determine if it is in transit or is leaving the effective range of its active interface, and thereby evaluate signal strength, using a mechanism such as a global positioning system (GPS). Such parameters may also be used by the mobile device 202 and/or the home agent 234 to determine if the active interface should be switched to a passive interface or if available interfaces should be closed.

The mobile application 302 may direct the information onto the active interface 304 in various ways. The mobile device 202 may notify the mobile application 302 of the active interface 304 and the mobile application 302 can direct information to the active interface 304. In another example, the mobile application 302 may direct the information to another mechanism included in the mobile device 202, such as a network interceptor, a proxy, or a routing mechanism that routes the information to the active interface 304. In yet another example, the mobile application 302 and the home application 306 may each include an application socket that connects its associated application 302 or 306 to the active interface 304.

Turning to the examples of interfaces mentioned above, the wireless interface 206 may include a wireless phone link using a first transmitter 216 and a wireless communications system such as a third generation (3G) wireless system, a second-and-a-half generation (2.5G) wireless system, General Packet Radio Service (GPRS), i-mode™ (NTT DoCoMo, Japan), Global System for Mobile (GSM) Communications, Code Division Multiple Access (CDMA), Time Division Multiple Access (TDMA)/Digital Advanced Mobile Phone Service (D-AMPS), or other similar system. The wireless interface 206 can be a modem connection that is relayed to an Internet Service Provider (ISP) that connects the mobile device 202 to the network 214.

The wireless LAN interface 208 may include a wireless connection to a LAN 224. The LAN 224 may be provided by a wireless Ethernet, Bluetooth, the Institute of Electrical and Electronics Engineers (IEEE) 802.11b standard (IEEE std. 802.11b-1999, published September 1999), Cellular Digital Packet Data (CDPD) connections, or other similar system. Information transmitted along the wireless LAN interface 208 may traverse through a second transmitter 218 to the LAN 224 and through a foreign Network Address Translation (NAT) proxy 226 from the LAN 224 to the network 214.

The wired network interface 210 may include a wired network connection through a connected network 228 such as an Ethernet. Information transmitted through the wired network interface 210 may traverse through the LAN 224 and the foreign NAT proxy 226 on its way to the network 214.

The direct wired interface 212 may include a direct connection 230 to the network 214, such as through a Digital Subscriber Line (DSL) connection, an Integrated Services Digital Network (ISDN) connection, a cable modem connection, or other similar connection.

The interface used by the mobile device 202 may connect to the home network 204 through a security mechanism such as a corporate firewall 232. Once the information is allowed through the corporate firewall 232, a router 236 can route the information to its proper destination (e.g., an Intranet 222, the home agent 234 such as a wireless data processing center, etc.). In this example, the destination is the home agent 234 (although the information's ultimate destination may be an application accessible by the home agent 234).

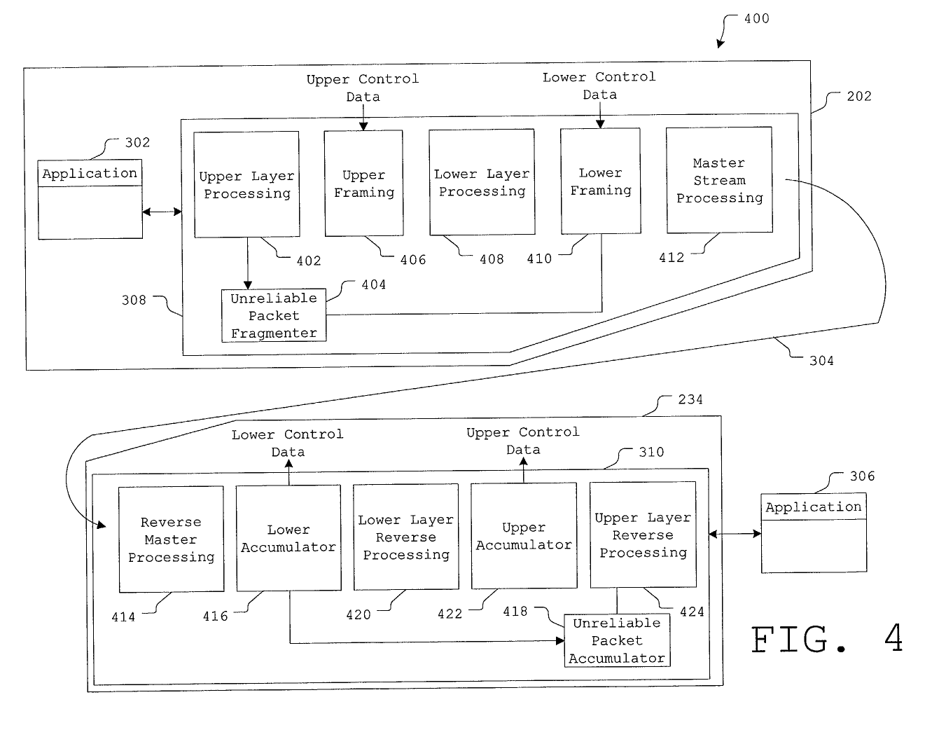

Referring to FIG. 4, another view 400 of the network configuration view 300 (see FIG. 3) shows example configurations of the mobile and home fp units 308 and 310. The mobile and home fp units 308 and 310 are discussed in this example in the context of the mobile application 302 transmitting information to the home application 306 across the active interface 304 although information may flow from the home application 306 to the mobile application 302.

The mobile application 302 sends information to the mobile fp unit 308 for processing and framing. The mobile fp unit 308 includes three stages of processing and two stages of framing. The first processing stage includes application layer-type processing. After the application processing, the mobile fp unit 308 includes two stages of framing, with another processing stage in-between the two framing stages. Then mobile fp unit 308 also includes a stream processing stage for information included in a stream of information. Each of these stages is described in more detail below.

The first processing stage includes upper layer processing performed by an upper layer processing unit 402. The upper layer processing unit 402 processes reliable information, that is, information (reliable packets or a reliable stream) that needs to be reliably sent to the home application 306 across the active interface 304 and maintain an order of frames. Examples of reliable information include audio information, video information, and other similar information. The upper layer processing unit 402 forwards unreliable packets of information to an unreliable packet fragmenter 404.

The unreliable packet fragmenter 404 may break the unreliable packets into fragments. Such fragmentation may facilitate transport of the packets over the available interface 304, e.g., break a packet that is too large to transport across the available interface 304 as one piece into fragments of sizes that the available interface 304 can handle or into fragment sizes that satisfy transportation criteria such as QoS.

The upper layer processing unit 402 processes the reliable information to conform it to transmission requirements imposed by the mobile application 302. Such processing may include roundtrip and bandwidth optimization, application-specific compression, basic QoS, and other similar operations. The upper layer processing unit 402 passes the processed reliable information to an upper framing unit 406.

The upper framing unit 406 frames the processed reliable information. Control information related to the reliable information sent to the upper framing unit 406 may also be framed in this framing stage. The upper framing unit 406 passes the framed reliable information and control information to the second processing stage, a lower layer processing unit 408.

The lower layer processing unit 408 processes information that does not need to be reliably sent to the home application 306. The lower layer processing unit 408 receives the unreliable information from the mobile application 302 via the upper layer processing unit 402 and the upper framing unit 406. Examples of lower layer processing include stream-related operations such as resistance to connection loss, reliable handoff of link traffic to another available interface, and other similar operations. The lower layer processing unit 408 passes the processed unreliable information (and the previously processed and framed reliable information) to a lower framing unit 410.

The lower framing unit 410 frames the processed unreliable information. Control information related to the unreliable information sent to the lower framing unit 410 may also be framed in this stage. Additionally, the lower framing unit 410 frames unreliable fragments or packets sent to the lower framing unit 410 from the unreliable packet fragmenter 404. The lower framing unit 410 passes the framed unreliable information and control information (and the previously processed and framed reliable information) to a master stream processing unit 412.

The master stream processing unit 412 processes the reliable and unreliable information as a stream. Such stream processing may include compression, security operations, proxy traversal, and other similar operations. The master stream processing unit 412 forwards the information to be sent on the available interface 304.

The information traverses the available interface and arrives at the home fp unit 310. The home fp unit 310 includes processing and framing units corresponding to the mobile fp unit's framing and processing units.

A reverse master processing unit 414 receives the information from the available interface 304 and removes the master stream processing performed by the master stream processing unit 412. Examples of such reverse processing include decompression, security verification, and other similar operations. The reverse master processing unit 414 forwards the information to a lower accumulator 416.

The lower accumulator 416 collects unreliable information and control information framed by the lower framing unit 410. The lower accumulator 416 forwards unreliable packets of information to an unreliable packet accumulator 418 that assembles and de-frames unreliable packets fragmented and framed by the unreliable packet fragmenter 404. The lower accumulator 416 forwards reliable information en route to reliable de-framing and processing (explained further below). In this way, unreliable packets and reliable information may proceed to their respective framing and processing stages without having to wait for the lower accumulator 416 to receive a full “lower layer” (e.g., a complete unreliable packet of information including a header and data).

The lower accumulator 416 collects unreliable information and de-frames full frames of unreliable information as it receives the full frames. The lower accumulator 416 passes the unframed control information associated with the unreliable information to the appropriate mechanism and the unframed unreliable information to a lower layer reverse processing unit 420.

The lower layer reverse processing unit 420 performs the processing operations of the lower layer processing unit 408 in reverse (not necessarily in reverse order). The lower layer reverse processing unit 420 forwards the unframed and processed unreliable information to an upper accumulator 422. The lower layer reverse processing unit 420 also forwards reliable information that it receives from the lower accumulator 416, without processing the reliable information, to the upper accumulator 422.

The upper accumulator 422 collects reliable information framed by the upper framing unit 406 and de-frames the reliable information as it receives the reliable information. In this way, the reliable information can be de-framed and forwarded on to processing as it is received, thereby hastening the reliable information's receipt at its destination. The upper accumulator 422 may forward reliable information before receiving the full fragment including that reliable information, so the upper accumulator 422 keeps a record of how much information is left to be received in that fragment and where to forward that remaining information (i.e., to which destination).

The upper accumulator 422 passes the unframed control information associated with the reliable information to the appropriate mechanism and the unframed reliable information to an upper layer reverse processing unit 424.

The upper accumulator 422 forwards unreliable information that it receives from the lower layer reverse processing unit 420 en route to the unreliable information's destination (e.g., the home application 306). In this way, once de-framed and reverse processed, the home fp unit 310 can pass unreliable information to its destination without having to wait for the home fp unit 310 to receive, de-frame, and process reliable information included in the same stream as the unreliable information.

The upper layer reverse processing unit 424 performs the processing operations of the upper layer processing unit 402 in reverse (not necessarily in reverse order). The upper layer reverse processing unit 424 forwards the unframed and processed reliable information en route to its destination (e.g., the home application 306). The upper layer reverse processing unit 424 also forwards unreliable information that it receives from the upper accumulator 422 and unreliable packets that it receives from the unreliable packet accumulator 418, without processing the unreliable information, to their respective destinations.

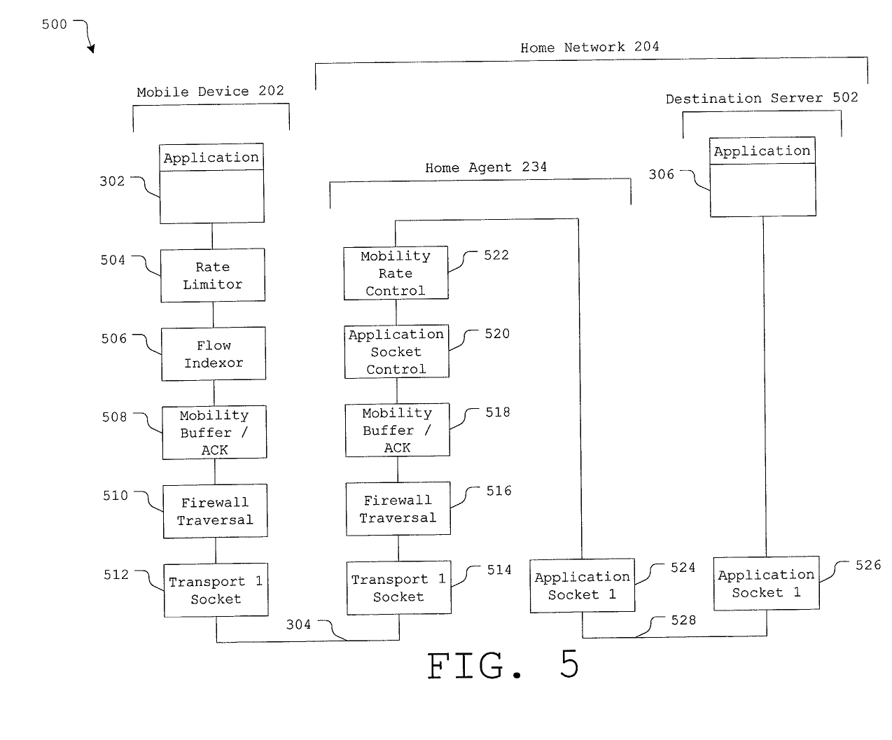

Referring to FIG. 5, an example of a stack 500 shows mechanisms that can be used in transmitting information between the mobile application 302 and the home application 306 along the active interface 304. In this example, the mobile application 302 transmits information to the home application 306 although the mechanisms and their functions can be adapted for information flowing from the home application 306 to the mobile application 302.

In the stack 500, the home application 306 is included in a destination server 502 included in the home network 204 and accessible by the home agent 234. The destination server 502 may, however, be located in another network.

The mobile application 302 sends information destined for the home application 306. The information passes through a number of mechanisms included in the mobile device 202 on its way to the active interface 304. The mobile device 202 may include more or fewer mechanisms, combining functions of one or more of these mechanisms and/or eliminating one or more mechanisms and their associated function(s).

A rate limitor 504 monitors information transfer rates and QoS parameters of the mobile application 302.

A flow indexor 506 monitors outgoing and incoming information for the mobile application 302. The flow indexor 506 can also frame information for the mobile application 302 with information for other mobile applications as described above.

A mobility buffer/ACK 508 stores outgoing information (e.g., as packets, as pointers to stored packets, as counted bytes in counter registers, etc.) until the mobile device 202 receives an acknowledgment from the home agent 234 indicating that the home agent 234 successfully received the information. The mobility buffer/ACK 508 also issues acknowledgments to the home agent 234 to acknowledge information received from the home agent 234.

The information also passes through a security mechanism, a firewall 510. The firewall 510 may compress/decompress, encrypt/decrypt, and/or otherwise process the information as appropriate. The firewall 510 may include multiple security mechanisms that each perform one or more different functions. For example, the firewall 510 may include a firewall mechanism and a security mechanism. The security mechanism may wrap the information to make the information appear as hypertext transfer protocol (HTTP) traffic so that the firewall mechanism (which checks for HTTP traffic) can allow the information to pass through the firewall 510 to the information's next destination.

The mobile device 202 sends the now processed and framed information through a mobile transport socket 512 associated with the active interface 304. The information traverses the active interface 304 (assuming no disconnects or other losses) to a home transport socket 514 included in the home agent 234.

Received by the home agent 234 via the home transport socket 512, the information passes through a number of mechanisms on its way to the destination server 502. As with the mechanisms included in the mobile device 202, the home agent 234 may include more or fewer mechanisms.

The information passes through a home firewall 516, a home mobility buffer/ACK 518, an application socket control mechanism 520, and a mobility rate control mechanism 522. Each of these mechanisms 516, 518, 520, and 522 performs tasks analogous to their counterparts included in the mobile device 202.

The home agent 234 maps the information, now appropriately processed and de-framed, to a home application socket 524 associated with the destination server 502 (or the home application 306). The home application socket 524 is linked to a destination application socket 526 associated with the home application 306 by a link 528 such as a virtual private network (VPN) connection. The information passes from the home application socket 524 to the destination application socket 526 and to the home application 306.

The sockets 512, 514, 524, and 526 may each include a software object that connects its associated application 302 or 306 to the active interface 304.

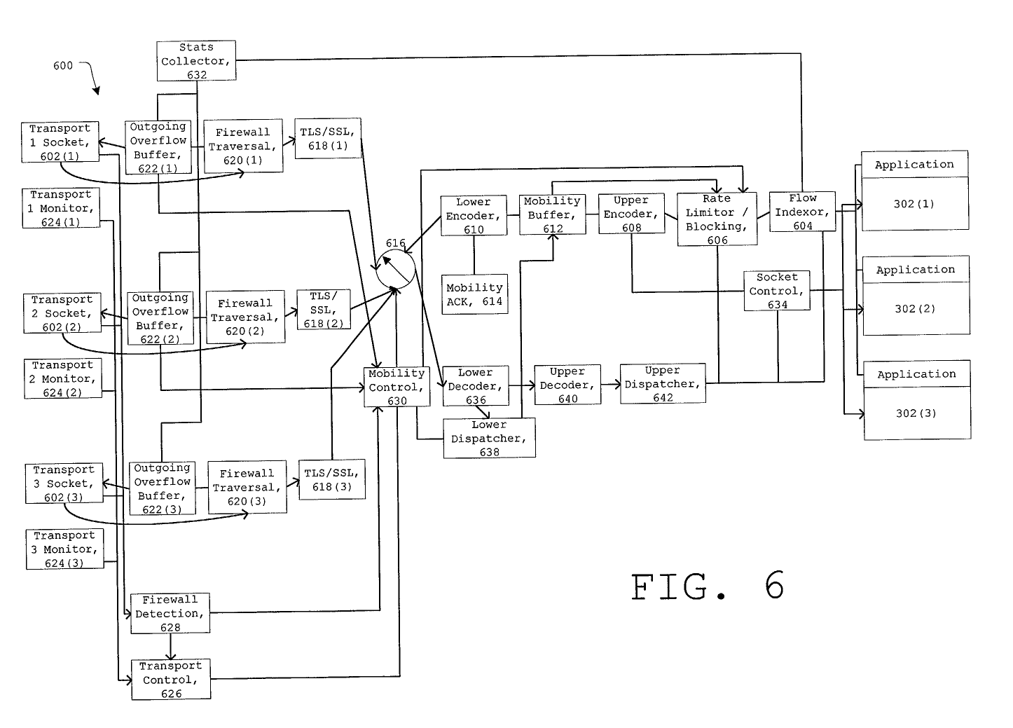

Referring to FIG. 6, an example of a source-side block diagram 600 illustrates in more detail mechanisms included in the mobile device 202. The mechanisms help multiple mobile applications 302(1), 302(2), and 302(3) communicate with a destination through an active one of the transport sockets 602(1), 602(2), and 602(3) (see, e.g., mobile transport socket 512 in FIG. 5) associated with an active interface. Three applications 302(1), 302(2), and 302(3) are shown in this example, but there could be any number of applications.

Information flowing from the applications 302(1), 302(2), and 302(3) to the transport sockets 602(1), 602(2), and 602(3) is controlled by a flow indexor 604 (see, e.g., the flow indexor 506 in FIG. 5), a rate limitor 606 (see, e.g., the rate limitor 504 in FIG. 5), and a socket control unit 634. From the flow indexor 604, the information, called outgoing information, is processed (e.g., packaged, compressed, and encrypted) and framed by an upper encoder 608 (see, e.g., the upper layer processing unit 402 and the upper framing unit 406 in FIG. 4) and a lower encoder 610 (see, e.g., the lower layer processing unit 408 and the lower framing unit 410 in FIG. 4) via a mobility buffer 612 (see, e.g., the mobility buffer/ACK 508 in FIG. 5) and a mobility buffer/ACK 614 (see, e.g., the mobility/ACK buffer 508 in FIG. 5).

A router 616 directs the outgoing information from the lower encoder 610 to an active one of the transport sockets 602(1), 602(2), and 602(3). En route to the active transport socket, a TLS/SSL unit 618(1), 618(2), 618(3) (see, e.g., the firewall traversal 510 in FIG. 5) associated with the active transport socket secures the outgoing information using TLS/SSL. A firewall traversal unit 620(1), 620(2), 620(3) (see, e.g., the firewall traversal 510 in FIG. 5) associated with the active transport socket can pass the outgoing information to its associated outgoing overflow buffer 622(1), 622(2), 622(3). The outgoing overflow buffer stores a copy of the outgoing information until the outgoing information's destination acknowledges successful receipt of the outgoing information. From the outgoing overflow buffer, the outgoing information travels to the associated transport socket 602(1), 602(2), or 602(3) en route to the active interface.

Transport monitors 624(1), 624(2), and 624(3) each monitor a transport socket 602(1), 602(2), and 602(3). Transport control unit 626, firewall detection unit 628, mobility control unit 630, and stats collector 632 also oversee general transportation and control issues for the outgoing information.

In this example, applications 302(1), 302(2), and 302(3) send information to a destination, but information may also flow from a destination to the applications 302(1), 302(2), and 302(3) with the described mechanisms handling the information, called incoming information, as appropriate. Additional mechanisms may be used in handling incoming information. The router 616 directs incoming information for processing and de-framing to a lower decoder 636 (see, e.g., the lower accumulator 416 in FIG. 4), a lower dispatcher 638 (see, e.g., the lower layer reverse processing unit 420 in FIG. 4), to an upper decoder 640 (see, e.g., the upper accumulator 422 in FIG. 4), and an upper dispatcher 642 (see, e.g., the upper layer reverse processing unit 424 in FIG. 4).

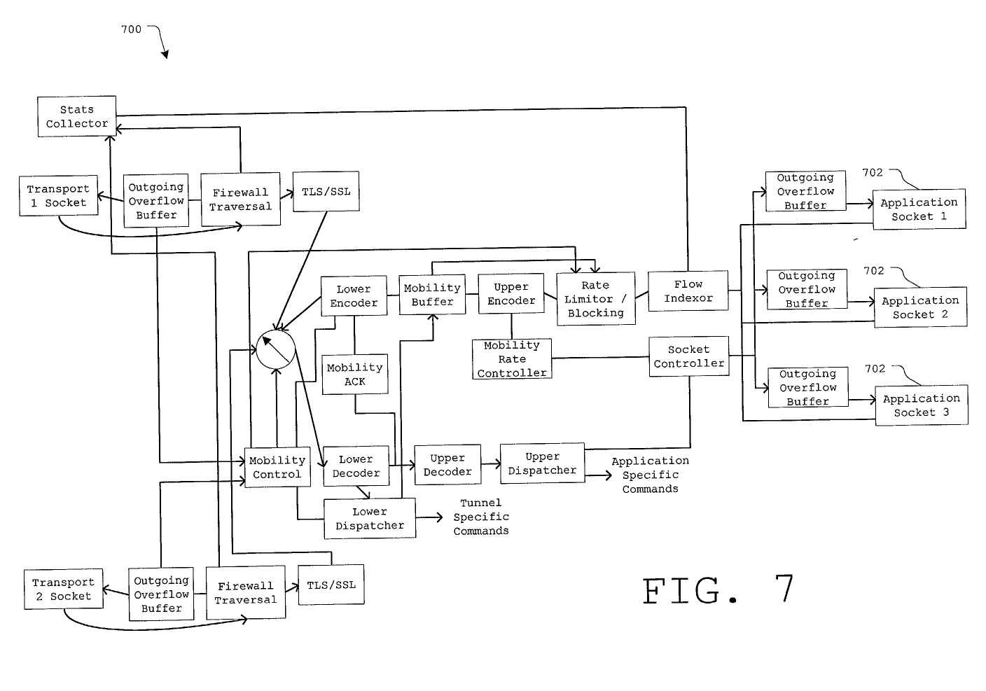

Referring to FIG. 7, a destination-side block diagram 700 illustrates an example of a setup pf the home agent 234 that can enable the home agent 234 to handle information sent to and received from the mobile applications 302(1), 302(2), and 303(3) (see FIG. 6). Each of three home applications is associated with an application socket 702. (There may be more or fewer home applications and associated application sockets.) The destination-side block diagram 700 resembles the source-side block diagram 600 and includes similarly-functioning mechanisms.

Generally, information traverses the active interface 304 on its way to the home network 204, the home agent 234, and the home application 306. When the home agent 234 receives the information, the home agent 234 splits (de-aggregates) the information back into separate streams (if necessary), accumulates and processes the information, and forwards the information to the appropriate application 306(1)-306(M), the home application 306 in this example.

The elements discussed with reference to FIGS. 2-7 can be implemented in a variety of ways. The mobile device 202 and the home network 204 are not limited to communicating with each other across an interface using the TCP protocol. Any protocol that offers reliability such as TCP, modified forms of TCP, reliable User Datagram Protocol (UDP), reliable layer two links, and other similar protocols can be used in the network configuration 200 and adapted to the described examples. Reliability in this context generally refers to transparently providing seamless connectivity, e.g., error detection, flow control, packet recovery, bandwidth control, security, etc., even if the interface between the mobile device 202 and the home network 204 changes.

The information communicated between the mobile device 202 and the home network 204 can include a packet including a full or partial IP packet (datagram) for some application included at the sender (either the mobile device 202 or the home network 204). The packet can include data (e.g., text, numbers, Boolean content, addresses, graphical content, control information, and the like), instructions (e.g., commands, requests, queries, and the like), or a combination of the two. Each sent packet may be part of a packet stream, where the packets in the packet stream fit together to form a contiguous group of data/instructions.

The network 214 typically includes a public network such as an Internet or other similar network. The network 214 may include a VPN set up between the mobile device 202 and the home network 204. A VPN generally refers to a protected (secured) communication network constructed using public network resources. Communications through the network 214 may be secured with a mechanism such as Transport Layer Security/Secure Socket Layer (TLS/SSL), wireless TLS (WTLS), or secure Hypertext Transfer Protocol (S-HTTP).

The home network 204, the Intranet 222, and the LAN 224 can each include any portion of a network that shares an independent, interconnected segment or domain such as a local area network (LAN) having a common address prefix or other similar network.

The mobile device 202 can include any device capable of communicating with the network 214 such as a mobile computer, a stationary computer, a telephone, a pager, a personal digital assistant, a key pad, an audio and/or video player, or other similar device.

The mobile device 202 may itself maintain or otherwise have access to the buffer 220. The buffer 220 can include any storage mechanism, such as a cache, a data queue, a buffer, a local or remote memory device, or other similar mechanism. The buffer 220 need not be any particular size.

The home agent 234 can include any device capable of communicating with the mobile device 202 and the network 214 such as a file server, a mobile computer, a stationary computer, a telephone, a pager, a personal digital assistant, or other similar device.

The interfaces 206, 208, 210, and 212 generally include routes for sending and/or receiving information. The interfaces 206, 208, 210, and 212 can include any kind and any combination of communication links such as modem links, wireless links, Ethernet links, cables, point-to-point links, infrared connections, fiber optic links, cellular links, Bluetooth, satellite links, and other similar links. The interfaces 206, 208, 210, and 212 (and other interfaces used in other examples) may be used in a system using NAT tunneling, a VPN based on a single link, dynamic-mobility enabled routing, bandwidth efficient tunneling, a wireless optimized mobile VPN, or other similar scenarios.

The network configuration 200 has been simplified for ease of explanation; the network configuration 200 may include additional elements such as networks, communication links, proxy servers, firewalls, or other security mechanisms, Internet Service Providers (ISPs), and other elements.

The techniques described here are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, and similar devices that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program may be implemented in a high level procedural or object oriented programming language to communicate with a machine system. However, the programs can be implemented in assembly or machine language, if desired. In any case, the language may be a compiled or interpreted language.

Each such program may be stored on a storage medium or device, e.g., compact disc read only memory (CD-ROM), hard disk, magnetic diskette, or similar medium or device, that is readable by a general or special purpose programmable machine for configuring and operating the machine when the storage medium or device is read by the computer to perform the procedures described in this document. The system may also be considered to be implemented as a machine-readable storage medium, configured with a program, where the storage medium so configured causes a machine to operate in a specific and predefined manner.

Other embodiments are within the scope of the following claims.

What is claimed is:

1. A method comprising:
preparing information included in a stream of information that requires reliable transmission from a source to a destination for transmission across a network link;
separately preparing other information included in the stream that does not require reliable transmission to the destination for transmission across the network link; and
preparing the stream for transmission across the network link.

2. The method of claim 1 further comprising aggregating information sent from applications into the stream.

3. The method of claim 1 in which preparing the information includes framing the information.

4. The method of claim 1 in which preparing the other information includes framing the other information.

5. The method of claim 1 in which preparing the information includes processing the information according to a transmission requirement of the source.

6. The method of claim 1 in which preparing the information includes processing the information according to a transmission requirement of the network link.

7. The method of claim 1 in which preparing the other information includes processing the other information according to a transmission requirement of the source.

8. The method of claim 1 in which preparing the other information includes processing the other information according to a transmission requirement of the network link.

9. The method of claim 1 further comprising, at a destination-side of the network link, de-framing the information.

10. The method of claim 1 further comprising, at a destination-side of the network link, de-framing the other information.

11. The method of claim 1 further comprising, at a destination-side of the network link, removing the preparations from the information.

12. The method of claim 1 further comprising, at a destination-side of the network link, removing the preparations from the other information.

13. The method of claim 1 in which the source includes a mobile unit.

14. The method of claim 1 in which the destination includes a home network.

15. The method of claim 1 in which the network link includes a wireless interface.

16. An article comprising:
a machine-readable medium which stores machine-executable instructions, the instructions causing a machine to:
prepare information included in a stream of information that requires reliable transmission from a source to a destination for transmission across a network link;
separately prepare other information included in the stream that does not require reliable transmission to the destination for transmission across the network link; and
prepare the stream for transmission across the network link.

17. The article of claim 16 in which preparing the information includes framing the information.

18. The article of claim 16 in which preparing the other information includes framing the other information.

19. The article of claim 16 in which preparing the information includes processing the information according to a transmission requirement of the source.

20. The article of claim 16 in which preparing the information includes processing the information according to a transmission requirement of the network link.

21. The article of claim 16 in which preparing the other information includes processing the other information according to a transmission requirement of the source.

22. The article of claim 16 in which preparing the other information includes processing the other information according to a transmission requirement of the network link.

23. A system comprising:
a first mechanism located at a first side of a network link and configured to
prepare information included in a stream of information that requires reliable transmission from a source to a destination for transmission across the network link,
separately prepare other information included in the stream that does not require reliable transmission to the destination for transmission across the network link, and
prepare the stream for transmission across the network link; and
a second mechanism located a second side of the network link and configured to:
handle preparations made to the stream at the first side in order to prepare the information and the other information included in the stream for delivery to the destination.

24. The system of claim 23 in which preparing the information and the other information includes framing the information and the other information.

25. The system of claim 23 in which preparing the information and the other information includes processing the information and the other information according to a transmission requirement of the source.

26. The system of claim 23 in which preparing the information and the other information includes processing the information and the other information according to a transmission requirement of the network link.

27. A method comprising:
processing information for transmission across a network link from a source to a destination in a first processing stage, a second processing stage, and a third processing stage;
framing the information between the first processing stage and the second processing stage;
framing the information between the second processing stage and the third processing stage.

28. The method of claim 27 in which the source includes a mobile unit.

29. A method comprising:
handling at a destination-side of a network link information included in a stream of information that requires reliable transmission from a source to a destination across the network link;
separately handling at the destination-side other information included in the stream that does not require reliable transmission to the destination for transmission across the network link;
forwarding the information to the destination immediately after handling the information; and
forwarding the other information to the destination immediately after handling the other information.

30. The method of claim 29 in which the destination-side includes a home network.
